(19) United States
(12) Patent Application Publication
(10) Pub. No.: US 2013/0209971 A1
(43) Pub. Date: Aug. 15, 2013

(54) METHOD OF MANAGING HEALTH OF A USER BASED UPON DATA RELATED TO PHYSICAL, MENTAL AND SPIRITUAL STATUS

(71) Applicant: Robert Luecke, Laguna Beach, CA (US)

(72) Inventor: Robert Luecke, Laguna Beach, CA (US)

(21) Appl. No.: 13/448,944

(22) Filed: Apr. 17, 2012

Related U.S. Application Data
(60) Provisional application No. 61/599,331, filed on Feb. 15, 2012.

(51) Int. Cl. G09B 19/00

(52) U.S. Cl. 434/127

(57) ABSTRACT

A method of managing health of a user includes receiving data related to weight change, net caloric intake, mental status, and spiritual status, all during the first time period. The method includes determining a moving average weight change per time increment per net caloric intake unit (MAWC) based upon the data related to weight change and net caloric intake. The method includes receiving a weight change goal and associated second time period. The method includes determining a recommended net caloric intake based upon the weight change goal and second time period, and the MAWC. The method includes receiving data related to weight change, net caloric intake, mental status, and spiritual status, all during the second time period. The method includes determining an activity recommendation based upon the received data related to the weight change, the net caloric intake, mental status, and spiritual status during the first and second time periods.

### CROSS-REFERENCE TO RELATED APPLICATIONS

This non-provisional patent application claims priority to U.S. provisional patent application Ser. No. 61/599,331 filed on Feb. 15, 2012 entitled “IT IS A CALCULATOR THAT TAKES YOUR PHYSICAL I.E. CALORIES. MENTAL I.E. REGARDING AND SPIRITUAL I.E. HOW MUCH TIME YOU SPEND MEDITATING TO AND CALCULATE WHAT YOU SHOULD BE DOING OF EACH TO GIVE YOU HOW MUCH YOU SHOULD BE DOING OF ALL THREE AND WHAT ACTIVITIES TO LOSE WEIGHT AND KEEP WEIGHT OFF,” the entire contents of which are incorporated herein by reference.

### STATEMENT RE: FEDERALLY SPONSORED RESEARCH/DEVELOPMENT

Not Applicable

### BACKGROUND

1. Technical Field

The present disclosure generally relates to health management methods, and more particularly, to a method of managing health of a user based upon data related to physical, mental and spiritual status.

2. Related Art

Healthy living and weight control are ever prevalent topics of concern. Many efforts have been made to utilize technology to facilitate weight control or weight loss goals for end users. There are numerous caloric counter and/or calorie calculator computer programs that are useful for end users to track their progress. Such programs may be used to record information about a user, including a user's weight, caloric intake and exercise or physical activities at any given time. Algorithms have been developed to determine target goals for caloric intake and activity. Such algorithms utilize data from end users regarding caloric intake from the consumption of food and beverages, and data regarding physical activities of the users. In addition, based upon an end user's profile, a resting metabolic rate may be determined. This data may be used to determine recommended amounts of consumption and/or activity to achieve the end user's weight goals.

The computer programs may be hosted online and available via the Internet as a software-as-a-service (SaaS). Mobile applications may be configured to run client-side and are configured as a user interface to send and receive data between the SaaS software and the user's mobile device. The programs may also entirely reside client-side.

These computer programs are intended to empower the individual to take charge and get healthy. Each of these programs, however, address only part of the needs of individuals seeking a healthier lifestyle and ignore many of the real barriers that most individuals face when trying to adopt and maintain a healthier lifestyle. The barriers include the fact that the individual is often left to himself/herself to find motivation, to implement a plan for achieving a healthier lifestyle, to effectively monitor progress, and to utilize a generic or non-individualized tailored plan. Moreover, each of these prior art programs only focus on the physical aspects of weight control, while ignoring the entirety of the wellbeing of the individual. Accordingly, there is a need in the art for an improved method and system for managing the health of an end user.

### BRIEF SUMMARY

According to an aspect of the invention, there is provided a method of managing health of a user. The method includes receiving from the user, via a computer, data related to weight change during a first time period. The method further includes receiving from the user, via a computer, data related to net caloric intake during the first time period. The method further includes determining, using a computer, a moving average weight change per time increment per net caloric intake unit (MAWC) based upon the received data related to weight change and the received data related to net caloric intake. The method further includes receiving from the user, via a computer, data related to a mental status of the user during the first time period. The method further includes receiving from the user, via a computer, data related to a spiritual status of the user during the first time period. The method further includes receiving from the user, via a computer, a weight change goal and associated second time period. The method further includes determining, using a computer, a recommended net caloric intake based upon the received weight change goal and associated second time period, and the MAWC. The method further includes receiving from the user, via a computer, data related to weight change during the second time period. The method further includes receiving from the user, via a computer, data related to net caloric intake during the second time period. The method further includes receiving from the user, via a computer, data related to a mental status of the user during the second time period. The method further includes receiving from the user, via a computer, data related to a spiritual status of the user during the second time period. The method further includes determining, using a computer, an activity recommendation based upon the received data related to the weight change, the net caloric intake, the mental status of the user, and the spiritual status of the user during the second time period and during the first period.

According to various embodiments, the data related to weight change during a first time period may correspond to a weight of the user. The data related to weight change during a second time period may correspond to a weight of the user. The data related to net caloric intake during the first time period may correspond to caloric intake consumed. The data related to net caloric intake during the second time period may correspond to caloric intake consumed. The data related to net caloric intake during the first time period may correspond to physical activity performed by the user. The data related to net caloric intake during the second time period may correspond to physical activity performed by the user. The data related to the mental status of the user during the first time period may correspond to an activity performed by the user. The data related to the mental status of the user during the second time period may correspond to an activity performed by the user. The data related to the mental status of the user during the first time period may correspond to a user-determined subjective ranking of the mental status of the user. The data related to the mental status of the user during the second time period may correspond to a user-determined subjective ranking of the mental status of the user. The data related to the spiritual status of the user during the first time period may correspond to an activity performed by the user. The data related to the spiritual status of the user during the second time period may correspond to an activity performed by the user. The data related to the spiritual status of the user during the first time period may correspond to a user-determined subjective ranking of the spiritual status of the user. The data related to the spiritual status of the user during the second time period may correspond to a user-determined subjective ranking of the spiritual status of the user. The method may further include communicating to the user, via a computer, information corresponding to the recommended caloric change per time unit. The method may further include communicating to the user, via a computer, the activity recommendation. The receiving of data related to the mental status of the user during the first time period may include communicating to the user, via a computer, a listing of activities. The listing of activities may be based upon input from the user. The method may further include determining, using a computer, a revised recommended net caloric intake based upon the received data related to the weight change, the net caloric intake, the mental status of the user, and the spiritual status of the user during the second time period and during the first period.

According to another embodiment, there is provided a method of managing health of a user. The method includes receiving from the user, via a computer, data related to weight change during a first time period. The method further includes receiving from the user, via a computer, data related to net caloric intake during the first time period. The method further includes determining, using a computer, a moving average weight change per time increment per net caloric intake unit (MAWC) based upon the received data related to weight change and the received data related to net caloric intake. The method further includes receiving from the user, via a computer, data related to a mental status of the user during the first time period. The method further includes receiving from the user, via a computer, data related to a spiritual status of the user during the first time period. The method further includes receiving from the user, via a computer, a weight change goal and associated second time period. The method further includes determining, using a computer, a recommended net caloric intake based upon the received weight change goal and associated second time period, and the MAWC. The method further includes receiving from the user, via a computer, data related to weight change during the second time period. The method further includes receiving from, the user, via a computer, data related to net caloric intake during the second time period. The method further includes receiving from the user, via a computer, data related to a mental status of the user during the second time period. The method further includes receiving from the user, via a computer, data related to a spiritual status of the user during the second time period. The method further includes determining, using a computer, a revised recommended net caloric intake based upon the received data related to the weight change, the net caloric intake, the mental status of the user, and the spiritual status of the user during the second time period and during the first period.

According to another aspect of the invention, there is provided a method of managing health of a user. The method includes receiving from the user, via a computer, data related to weight change during a first time period. The method further includes receiving from the user, via a computer, data related to net caloric intake during the first time period. The method further includes determining, using a computer, a moving average weight change per time increment per net caloric intake unit (MAWC) based upon the received data related to weight change and the received data related to net caloric intake. The method further includes receiving from the user, via a computer, data related to a mental status of the user during the first time period. The method further includes receiving from the user, via a computer, a weight change goal and associated second time period. The method further includes determining, using a computer, a recommended net caloric intake based upon the received weight change goal and associated second time period, and the MAWC. The method further includes receiving from the user, via a computer, data related to weight change during the second time period. The method further includes receiving from the user, via a computer, data related to net caloric intake during the second time period. The method further includes receiving from the user, via a computer, data related to a mental status of the user during the second time period. The method further includes determining, using a computer, an activity recommendation based upon the received data related to the weight change, the net caloric intake, and the mental status of the user during the second time period and during the first period.

According to yet another aspect of the invention, there is provided a method of managing health of a user. The method includes receiving from the user, via a computer, data related to weight change during a first time period. The method further includes receiving from the user, via a computer, data related to net caloric intake during the first time period. The method further includes determining, using a computer, a moving average weight change per time increment per net caloric intake unit (MAWC) based upon the received data related to weight change and the received data related to net caloric intake. The method further includes receiving from the user, via a computer, data related to a spiritual status of the user during the first time period. The method further includes receiving from the user, via a computer, a weight change goal and associated second time period. The method further includes determining, using a computer, a recommended net caloric intake based upon the received weight change goal and associated second time period, and the MAWC. The method further includes receiving from the user, via a computer, data related to weight change during the second time period. The method further includes receiving from the user, via a computer, data related to net caloric intake during the second time period. The method further includes receiving from the user, via a computer, data related to a spiritual status of the user during the second time period. The method further includes determining, using a computer, an activity recommendation based upon the received data related to the weight change, the net caloric intake, and the spiritual status of the user during the second time period and during the first period.

The presently contemplated embodiments will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram showing an exemplary networked computing environment in which various embodiments of the present disclosure may be implemented;

FIG. 2 is a flowchart illustrating an embodiment of a method of managing health of a user:

FIG. 3 is a continuation of the flowchart in FIG. 2: and

FIG. 4 is an exemplary display screen displaying a data chart.

Common reference numerals are used throughout the drawings and the detailed description to indicate the same elements.

### DETAILED DESCRIPTION

The detailed description set forth below in connection with the appended drawings is intended as a description of the presently preferred embodiments of the invention, and is not intended to represent the only form in which the present methods and devices may be developed or utilized. It is to be understood, however, that the same or equivalent functions may be accomplished by different embodiments that are also intended to be encompassed within the spirit and scope of the invention. It is further understood that the use of relational terms such as first, second, and the like are used solely to distinguish one from another entity without necessarily requiring or implying any actual such relationship or order between such entities.

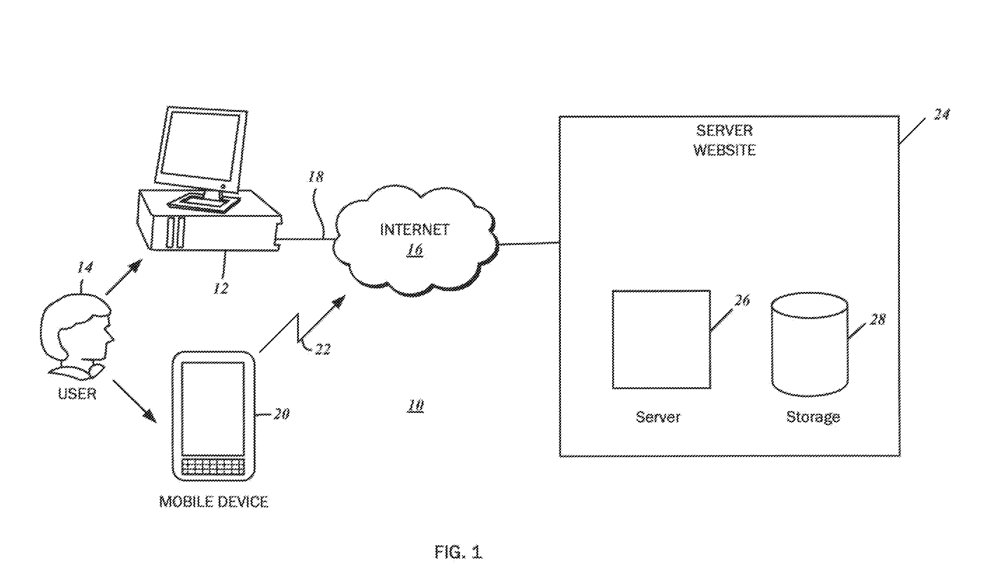

FIG. 1 depicts one exemplary embodiment of a networked computing environment where various embodiments of a system and method of managing health of a user may be implemented. Although specific components thereof are described, those having ordinary skill in the art will recognize that any other suitable component may be substituted. One component is a client computer system 12 operated by a user 14. The client computer system 12 may be a conventional personal computer device including a central processing unit, memory, and various input and output devices such as keyboards, mice, and display units. The client computer system 12 is connectable to the global Internet 16 via an Internet link 18.

Some embodiments can utilize a mobile device 20 that is likewise connectable to the Internet 16 via a wireless Internet link 22. As will be discussed in greater detail below, invocation of the system and method of managing health of a user 14 need not be restricted to be from a set physical location as may be the case with the client computer system 12. Untethered data communication modalities such as the mobile device 20 make this possible, and examples thereof include cellular phones, smart phones, and tablet computing devices.

The mobile device 20 and the client computer system 12 are understood to have similar features, in particular, executable instructions of a web browser application that are loaded thereon. The web browser application communicates with various web servers also connected to the Internet 16 over the hypertext transfer protocol (HTTP), among other protocols known in the art. Requests for data are initiated by the mobile device 20 or the client computer system 12 and transmitted to the server 26, while the server 26 transmits the requested data to the mobile device 20 or the client computer system 12. For purposes of the present disclosure, the mobile device 20 will be referenced as a specific kind of the client computer system 12, and thus the terms are, for the most part, interchangeable. Where features specifically relevant to the mobile device 20 are being discussed, it will be referenced thus.

The networked computing environment 10 includes a server website 24 that is also connected to the Internet 16. The server website 24 includes at least one server 26 and storage 28 for retaining various data used by the server website 24.

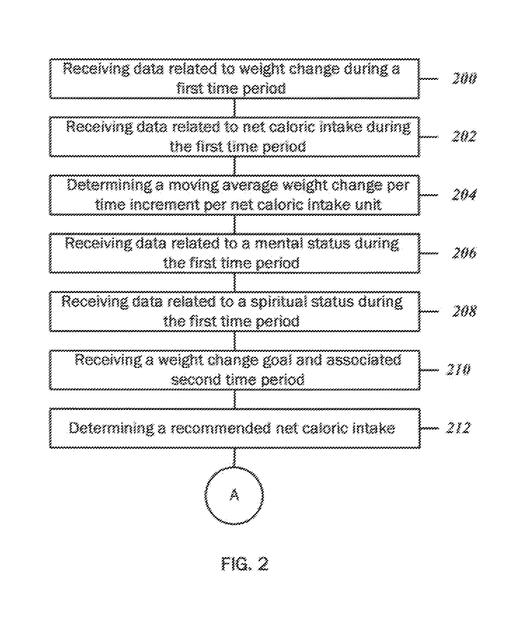

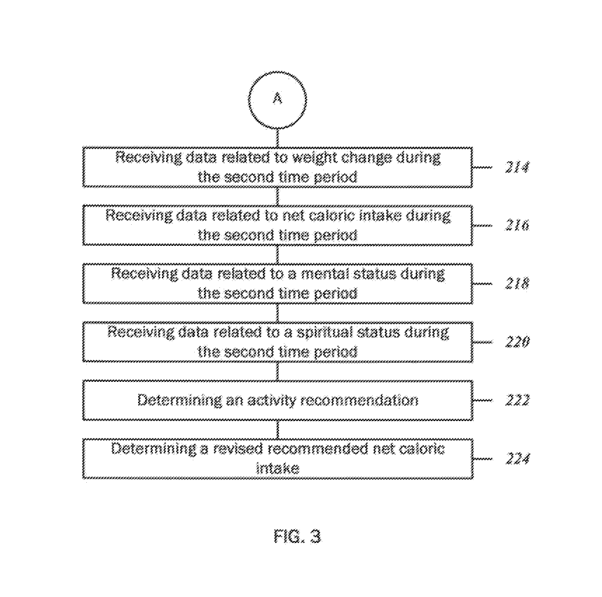

According to an aspect of the invention, there is provided a method of managing health of the user 14. Referring now to FIG. 2 is a flowchart illustrating an embodiment of a method of managing health of the user 14. FIG. 3 is a continuation of the flowchart in FIG. 2.

The method includes a step 200 of receiving from the user 14, via a computer, data related to weight change during a first time period. The method further includes a step 202 of receiving from the user 14, via a computer, data related to net caloric intake during the first time period. The method further includes a step 204 of determining using a computer, a moving average weight change per time increment per net caloric intake unit (MAWC) based upon the received data related to weight change and the received data related to net caloric intake. The method further includes a step 206 of receiving from the user 14, via a computer, data related to the mental status of the user 14 during the first time period. The method further includes a step 208 of receiving from the user 14, via a computer, data related to a spiritual status of the user 14 during the first time period. The method further includes a step 210 of receiving from the user 14, via a computer, a weight change goal and associated second time period. The method further includes a step 212 of determining, using a computer, a recommended net caloric intake based upon the received weight change goal and associated second time period, and the MAWC. The method further includes a step 214 of receiving from the user 14, via a computer, data related to weight change during the second time period. The method further includes a step 216 of receiving from the user 14, via a computer, data related to net caloric intake during the second time period. The method further includes a step 218 of receiving from the user 14, via a computer, data related to the mental status of the user 14 during the second time period. The method further includes a step 220 of receiving from the user 14, via a computer, data related to spiritual status of the user 14 during the second time period. The method further includes a step 222 of determining, using a computer, an activity recommendation based upon the received data related to the weight change, the net caloric intake, the mental status of the user 14, and the spiritual status of the user 14 during the second time period and during the first period. The method further includes a step 224 of determining, using a computer, a revised recommended net caloric intake based upon the received data related to the weight change, the net caloric intake, the mental status of the user 14, and the spiritual status of the user 14 during the second time period and during the first period.

It is contemplated that other embodiments of the invention may include less than all of the steps 200-224. Moreover, it is contemplated that the various steps may be implemented in alternative sequence.

As mentioned above, the various steps of the method described above may utilize “a computer.” Such computer may take the form of any of the exemplary client computer system 12, mobile device 20, and/or the server website 24 with the server 26. For example, the method may be implemented through the use of a computer software program, installed on the server 26. In another embodiment, the method may be implemented through the use of a computer software program installed entirely client-side on the client computer system 12. An embodiment in the context of a software implementation installed on a server 26 will now be discussed below for purposes of expanding upon a method of the present invention. It is understood that such software implementation will be generally and interchangeably referred to as software, software programming, application and the like.

As used herein the terminology “during a first time period” refers to a time span that may be based upon a date or between two dates, and may be further defined by a time of day of such date(s). Other time increments may be contemplated such as a given week. Such date/time information is provided by the user 14 when inputting related data as provided in the methods described herein. For example, in relation to the step 202 a user 14 may input a specific date in which calories were consumed and a different date when a certain physical activity was completed. The two dates would define the first time period. Were another temporal event to be identified as being associated with the first time period, to the extent that the same is outside the currently defined first time period the same would be revised to the longer time period. The terminology “during a second time period” refers to a time span determined in a similar manner as the first time period discussed above but in the context of temporal events and data. The first time period is temporally before the second time period, and such time periods are not necessarily fixed and may change over time. In this regard, the time periods are relative to each other. The first time period may be revised as additional data associated with updated temporal events are provided by the user 14 as time goes on. In this regard, the first time period may be “moving” time period as data is continually updated by the user 14. In addition, as time goes on, the total length of the second time period is anticipated to shrink as the end date/time of the second time period is approached.

In regards to the step 200 of receiving from the user 14, via a computer, data related to weight change during a first time period. The data related to weight change during a first time period may correspond to a weight of the user 14. The user 14 may input such weight data through the client computer system 12. This data is then transmitted via the Internet 16 to the server website 24, and specifically the server 26. The weight data may be stored in the storage 28. In an embodiment, the user 14 would input a specific weight, such as 200 lbs. and a specific time and/or date. It is contemplated that the user may also or alternatively input information such as body fat percentage or body mass index.

According to various embodiments, as mentioned above, the method includes a step 202 of receiving from the user 14, via a computer, data related to net caloric intake during the first time period. The data related to net caloric intake during the first time period may correspond to caloric intake consumed. This may be inputted to the computer by the user 14 in the form a specific calorie amount. It may also be in the form of indicated food/beverage items and quantities of such items. In this regard, a library of data would need to be utilized by the server 26 that can index and/or calculate the inputted food/beverage items and quantities to corresponding caloric values. This library of data may be locally stored in the storage 28 or accessed from another storage source. The software may be configured to allow the user 14 to customize the library of data by revising caloric values of the various food/beverage items. The software may also be configured to allow the user 14 to input or define additional food/beverage items with corresponding caloric values.

The data related to net caloric intake during the first time period may correspond to physical activity performed by the user 14. In this regard, for a given date/time the user 14 may be prompted by the software to select a pre-defined activity (e.g., moderate walking, brisk walking, jogging, strenuous weightlifting, etc.). A drop down menu or other presentation screen may be used to facilitate such selection. This listing of activities would have corresponding caloric values per time increment. The user 14 would also be prompted to input an associated amount of time the activity was performed. With this data, an estimated amount of calories expended for the indicated physical activity may be determined. The listing of activities and corresponding caloric values per time increment is contemplated to be compiled in a library of data stored in the storage 28 or accessed from another storage source. A user-determined subjective ranking of the performance of the physical activity may be solicited by the software. For example, the user 14 may be prompted to input a selection of in response to a question regarding how was the particular workout of “ok,” “good” or “great.”

It is contemplated that the net caloric intake would also take into consideration a determination of the resting metabolic rate of the user 14. The methods for such determination may be chosen from those which are well know to one of ordinary skill in the art, and may involve additional information about the user 14 such as gender, height, age, daily activity level (e.g., desk job, student, “on my feet,” light labor, heavy labor, etc.), diseases, disabilities, and eating habit classification (e.g., vegan, vegetarian, carnivore, gluten-free, organic, etc.). Such information may be prompted from the user 14 during an initial registration or upon the user 14 completing a user profile as facilitate by the software. Various equations are well known, such as those based upon the Harris-Benedict equation, as well as various tables/charts derived using such equations. Such equations may be very simplified (with various user related assumptions) or more complex, such as utilizing additional data, such as ratio of muscle mass to fat mass, heart rate data, body composition, etc.

The method further include receiving from the user 14, via a computer, data related to a physical status of the user 14 during the first time period. In this regard, data related to a physical status of the user 14 may include caloric intake data and physical activity data discussed above. In addition the data related to the physical status of the user 14 during the first time period may correspond to a user-determined subjective ranking of the physical status of the user 14. For example, the user 14 may be prompted to input a value of 1-10 with “1” being a poor or bad physical feeling to “10” being a physically fantastic feeling. Subjective rankings or rating can be applied to the physical activities as well.

The method further includes a step 204 of determining, using a computer, a moving average weight change per time increment per net caloric intake unit (MAWC) based upon the received data related to weight change and the received data related to net caloric intake. In this regard, the method may also include receiving from the user 14 updates of the weight of the user 14 at differing times. Until actual data is received from the user 14, the software may initially utilize various assumptions of a MAWC value based upon data received during the account or profile setup. However, after a time period, such a seven days of entries, the software will have a full week of data to utilize and a seven day moving average may be calculated with respect to any number of variables include a moving average weight change per time increment per net caloric intake unit (MAWC). In another embodiment, only the most recent data may be of interest and the moving average may only include a single data point such as the previous day's weight change related data.

It is understood that the calorie intake less burned calories is equal to net caloric intake. A weight gain or loss of a user 14 for any given period divided by the net calorie intake for the same given period is equal to the net gain or loss per calorie for that user 14. For example, the user 14 inputs a loss of 2 lbs. in 2 weeks and a net caloric intake of 26000 calories during that same timeframe. This results in a calculated value of 0.0000769 lbs./calorie for that 2 week moving average.

The method further includes a step 206 of receiving from the user 14, via a computer, data related to the mental status of the user 14 during the first time period. The data related to the mental status of the user 14 during the first time period may correspond to an activity performed by the user 14. In this regard, for a given date/time the user 14 may be prompted by the software to select a pre-defined activity (e.g. read a book, take a class, sharing information on a website, attending school, time with friends, time with family, etc.). A drop down menu or other presentation screen may be used to facilitate such selection. The receiving of data related to the mental status of the user 14 during the first time period may include communicating to the user 14, via a computer, a listing of activities. The listing of activities may be based upon input from the user 14. It is also understood that some mental activities may also be physical and/or spiritual activities as well.

The data related to the mental status of the user 14 during the first time period may correspond to a user-determined subjective ranking of the mental status of the user 14. For example, the user 14 may be prompted to input a value of 1-10 with “l” being a sluggish feeling to “10” being in lucid consciousness.

The method further includes a step 208 of receiving from the user 14, via a computer, data related to a spiritual status of the user 14 during the first time period. The data related to the spiritual status of the user 14 during the first time period may correspond to an activity performed by the user 14. In this regard, for a given date/time the user 14 may be prompted by the software to select a pre-defined activity (e.g. pray, get a massage/pedicure/manicure, charity, spend time with family, spend time with friends, on vacation, helping a family member or a friend, time relaxing not thinking of anything, attend religious service, travel to a religious location, etc.). A drop down menu or other presentation screen may be used to facilitate such selection. The receiving of data related to the spiritual status of the user 14 during the first time period may include communicating to the user 14, via a computer, a listing of activities. The listing of activities may be based upon input from the user 14. It is also understood that some spiritual activities may also be mental and/or physical well. In this regard, the software can be configured to take input from the user 14 so as to not only define what a particular activity is but also what classification(s) is would be in terms of physical, mental and/or spiritual.

The data related to the spiritual status of the user 14 during the first time period may correspond to a user-determined subjective ranking of the spiritual status of the user 14. For example, the user 14 may be prompted to input a value of 1-10 with “1” being a depressed feeling to “10” being in bliss.

The method further includes a step 210 of receiving from the user 14, via a computer, a weight change goal and associated second time period. For example, the user 14 may want to lose 15 lbs. in 3 weeks. Other goals may also be received, such as wanting to achieve a user-determined subjective ranking of the physical status (such as an “8” for physical status within 3 weeks).

The method further includes a step 212 of determining, using a computer, a recommended net caloric intake based upon the received weight change goal and associated second time period, and the moving average weight change per time increment per net caloric intake unit (MAWC). In the example above, the user 14 had input a loss of 2 lbs. in 2 weeks and a net caloric intake of 26000 calories during that same timeframe. This results in a calculated value of 0.0000769 lbs./calorie for that 2 week moving average or 0.0000384 lbs./calorie for a 1 week moving average based upon that same data. The user 14 may additionally set a weight change goal of losing 5 lbs. in 4 weeks. As such, from this information the software may recommend a net caloric intake based upon the inputted weight change goal during a second timeframe and the calculated 2 week MAWC. The weight change goal divided by second timeframe is 5 lbs./4 weeks or 1.25 lbs. per week. This is the rate of weight loss per week in order to achieve the weight loss goal at the end of the second timeframe. This represents a 25% increase in weight loss per week when compared to the 2 week MAWC. In order to achieve the weight loss goal the user may have a net caloric intake of 25% less or 0.25(26000) calories/2 weeks (equal to 3.250 less calories per week). This results in a calculation of 26000 calories less 3250 calories equaling 9.750 calories per week. For the second timeframe 39,000 calories is the net caloric intake per 4 weeks. As such the MAWC is based upon the prior inputted weight change data consisting of the weight change and the associated timeframe. The “moving average” connotes a updating processes as more data is continually inputted in to the software. By using a historic moving average to calculate recommended caloric intake this results in “fresh” data being used to predict how the body of the user 14 would react (i.e. change in weight) based upon caloric intake.

The method further includes a step 214 of receiving from the user 14, via a computer, data related to weight change during the second time period. The data related to weight change during a second time period may correspond to a weight of the user. The method further includes a step 216 of receiving from the user 14, via a computer, data related to net caloric intake during the second time period. Such data may be similar in nature to that of the first time period. The data related to net caloric intake during the second time period may correspond to physical activity performed by the user 14. The data related to net caloric intake during the second time period may correspond to caloric intake consumed.

The method further includes a step 218 of receiving from the user 14, via a computer, data related to the mental status of the user 14 during the second time period. Such data may be similar in nature to that of the first time period. The data related to the mental status of the user 14 during the second time period may correspond to an activity performed by the use 14. The data related to the mental status of the user 14 during the second time period may correspond to a user-determined subjective ranking of the mental status of the user 14.

The method further includes a step 220 of receiving from the user 14, via a computer, data related to spiritual status of the user 14 during the second time period. Such data may be similar in nature to that of the first time period. The data related to the spiritual status of the user during the second time period may correspond to an activity performed by the user 14. The data related to the spiritual status of the user 14 during the second time period may correspond to a user-determined subjective ranking of the spiritual status of the user 14.

The method further includes a step 222 of determining, using a computer, an activity recommendation based upon the received data related to the weight change, the net caloric intake, the mental status of the user 14, and the spiritual status of the user 14 during the second time period and during the first period. In this regard, various algorithms may be implemented. Trends in the data received by the software may be used to make recommendations.

As such, while using data such as that used to compute a moving average weight change is initially useful to make net caloric intake recommendations to the user 14, such data alone does account for how the user 14 may feel physically, mentally and spiritually (i.e. does not account for each physical, mental and spiritual status of the user 14). In this regard the present invention recognizes that weight gain or loss may be affected by the status of the user physically, mentally and/or spiritually. Some correlations may be as a result of the user simply having a higher likelihood to eat and/or exercise better when they have performed various activities which help them achieve a higher mental or physical status. Because this data is user-determined and is subjective in nature the software is inherently customized to various users 14. In another embodiment, the system may only consider data related to physical weight changes and mental status, and in another system may only consider data related to physical weight changes and spiritual status.

The method may further include communicating to the user 14, via a computer, the activity recommendation. It is contemplated that the communications to the user 10 through various electronic means. For example, information may be communicated to the user via display screens as accessed through the server website 24. However, other communications modalities may be utilized such as email or text messages that may be accessed by the user 14 via the mobile device 20. Such activities may be related to physical, mental and/or spiritual activities likely to result in a high status based upon past data collected from the user 14.

The method further includes a step 224 of determining, using a computer, a revised recommended net caloric intake based upon the received data related to the weight change, the net caloric intake, the mental status of the user 14, and the spiritual status of the user 14 during the second time period and during the first period.

With this additional data, the remaining portion of the second timeframe may be reassessed and further updated recommendations to the user 14 regarding net caloric intake may be provided to the user 14. In this regard, 2 weeks into a 4 week second timeframe, the user 14 may be “ahead of pace” with regard to a weight change goal to be reached at the end of the 4 week second timeframe. The system may provide the user 14 with data related to an updated net caloric intake (e.g., the user 14 may consume a greater amount that initially recommended and still end up on track). In this regard, the method may further include communicating to the user, via a computer, information corresponding to the recommended caloric change per time unit.

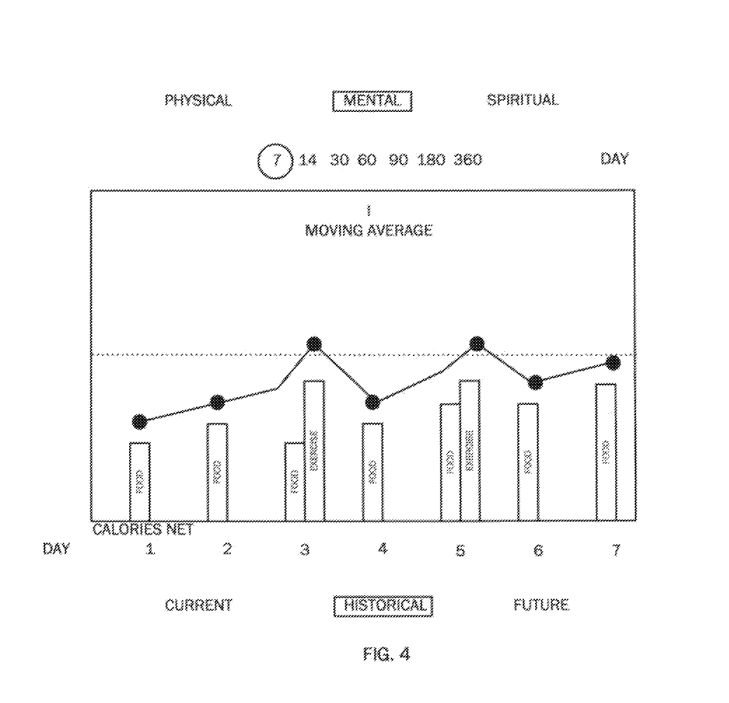

Each of the physical status, mental status and spiritual status may be tracked in connection with changes to weight over a time frame. It is contemplated that the various data collected from the user and that which is calculated or determined by the software programming may be displayed for the user via a display device. Such data may be presented relative or as correlated to each other, such as via any number of charts and graphs. For example, any of the data may be plotted in relation to time, historically as well as in a predictive or future recommended manner. Referring now to FIG. 4 there is depicted an example graphical representation of caloric intake and calories burned via exercise for each of seven days. Overlayed with this data is a plot of “mental” status of the user 14. Presenting data in this manner may reveal correlations not previously realized by the user 14. For example, the user 14 may come to the self realization that he/she feels a better “mentally” on those days where he/she has also exercised, and so forth. The system may additionally prompt the user to provide goals related to user-determined subjective ranking of the physical, mental and spiritual status of the user 14. In this regard, also indicated in plotted (dashed) line is the metal status goal value of the user 14. This data may reveal correlations such as how certain physical activities or exercise may also help to increase a mental status of the user, for example. Accordingly, by tracking the various the physical, the mental and the spiritual status of the user 14, this data can be used in a variety of algorithms to prioritize various activities (which may historically be recognized by the software to impact the user 14 in differing ways. It is contemplated that the software may calculate any number of metrics based upon any of the collected or calculated data. An overall wellness scoring may be provided that includes components representative of the physical, the mental and/or the spiritual status of the user 14. The user 14 may be prompted to input goals of such a wellness scoring as well.

The particulars shown herein are by way of example and for purposes of illustrative discussion of the embodiments of the present invention only and are presented in the cause of providing what is believed to be the most useful and readily understood description of the principles and conceptual aspects. In this regard, no attempt is made to show more details than is necessary for a fundamental understanding of the disclosure, the description taken with the drawings making apparent to those skilled in the art how the several forms of the presently disclosed invention may be embodied in practice.

What is claimed is:

1. A method of managing health of a user, the method comprising:
receiving from the user, via a computer, data related to weight change during a first time period;
receiving from the user, via a computer, data related to net caloric intake during the first time period;
determining, using a computer, a moving average weight change per time increment per net caloric intake unit (MAWC) based upon the received data related to weight change and the received data related to net caloric intake;
receiving from the user, via a computer, data related to a mental status of the user during the first time period;
receiving from the user, via a computer, data related to a spiritual status of the user during the first time period;
receiving from the user, via a computer, a weight change goal and associated second time period;
determining, using a computer, a recommended net caloric intake based upon the received weight change goal and associated second time period, and the MAWC;
receiving from the user, via a computer, data related to weight change during the second time period;
receiving from the user, via a computer, data related to net caloric intake during the second time period;
receiving from the user, via a computer, data related to a mental status of the user during the second time period;
receiving from the user, via a computer, data related to a spiritual status of the user during the second time period; and
determining, using a computer, an activity recommendation based upon the received data related to the weight change, the net caloric intake, the mental status of the user, and the spiritual status of the user during the second time period and during the first period.

2. The method of claim 1 wherein the data related to weight change during a first time period corresponds to a weight of the user.

3. The method of claim 1 wherein the data related to weight change during a second time period corresponds to a weight of the user.

4. The method of claim 1 wherein the data related to net caloric intake during the first time period corresponds to caloric intake consumed.

5. The method of claim 1 wherein the data related to net caloric intake during the second time period corresponds to caloric intake consumed.

6. The method of claim 1 wherein the data related to net caloric intake during the first time period corresponds to physical activity performed by the user.

7. The method of claim 1 wherein the data related to net caloric intake during the second time period corresponds to physical activity performed by the user.

8. The method of claim 1 wherein the data related to the mental status of the user during the first time period corresponds to an activity performed by the user.

9. The method of claim 1 wherein the data related to the mental status of the user during the second time period corresponds to an activity performed by the user.

10. The method of claim 1 wherein the data related to the mental status of the user during the first time period corresponds to a user-determined subjective ranking of the mental status of the user.

11. The method of claim 1 wherein the data related to the mental status of the user during the second time period corresponds to a user-determined subjective ranking of the mental status of the user.

12. The method of claim 1 wherein the data related to the spiritual status of the user during the first time period corresponds to an activity performed by the user.

13. The method of claim 1 wherein the data related to the spiritual status of the user during the second time period corresponds to an activity performed by the user.

14. The method of claim 1 wherein the data related to the spiritual status of the user during the first time period corresponds to a user-determined subjective ranking of the spiritual status of the user.

15. The method of claim 1 wherein the data related to the spiritual status of the user during the second time period corresponds to a user-determined subjective ranking of the spiritual status of the user.

16. The method of claim 1 wherein the method further includes:
communicating to the user, via a computer, information corresponding to the recommended caloric change per time unit.

17. The method of claim 1 wherein the method further includes:
communicating to the user, via a computer, the activity recommendation.

18. The method of claim 1 wherein the receiving of data related to the mental status of the user during the first time period includes
communicating to the user, via a computer, a listing of activities.

19. The method of claim 18 wherein the listing of activities is based upon input from the user.

20. The method of claim 1 further includes:
determining, using a computer, a revised recommended net caloric intake based upon the received data related to the weight change, the net caloric intake, the mental status of the user, and the spiritual status of the user during the second time period and during the first period.

21. A method of managing health of a user, the method comprising:
receiving from the user, via a computer, data related to weight change during a first time period;
receiving from the user, via a computer, data related to net caloric intake during the first time period;
determining, using a computer, a moving average weight change per time increment per net caloric intake unit (MAWC) based upon the received data related to weight change and the received data related to net caloric intake;
receiving from the user, via a computer, data related to the user's mental status during the first time period;
receiving from the user, via a computer, data related to the user's spiritual status during the first time period;
receiving from the user, via a computer, a weight change goal and associated second time period;
determining, using a computer, a recommended net caloric intake based upon the received weight change goal and associated second time period, and the MAWC;
receiving from the user, via a computer, data related to weight change during the second time period;
receiving from the user, via a computer, data related to net caloric intake during the second time period;
receiving from the user, via a computer, data related to a mental status of the user during the second time period;
receiving from the user, via a computer, data related to a spiritual status of the user during the second time period; and
determining, using a computer, a revised recommended net caloric intake based upon the received data related to the weight change, the net caloric intake, the mental status of the user, and the spiritual status of the user during the second time period and during the first period.

22. A method of managing health of a user, the method comprising:
receiving from the user, via a computer, data related to weight change during a first time period;
receiving from the user, via a computer, data related to net caloric intake during the first time period;
determining, using a computer, a moving average weight change per time increment per net caloric intake unit (MAWC) based upon the received data related to weight change and the received data related to net caloric intake;
receiving from the user, via a computer, data related to a mental status of the user during the first time period;
receiving from the user, via a computer, a weight change goal and associated second time period;
determining, using a computer, a recommended net caloric intake based upon the received weight change goal and associated second time period, and the MAWC;
receiving from the user, via a computer, data related to weight change during the second time period;
receiving from the user, via a computer, data related to net caloric intake during the second time period;
receiving from the user, via a computer, data related to a mental status of the user during the second time period; and
determining, using a computer, an activity recommendation based upon the received data related to the weight change, the net caloric intake, and the mental status of the user during the second time period and during the first period.

23. A method of managing health of a user, the method comprising:
receiving from the user, via a computer, data related to weight change during a first time period;
receiving from the user, via a computer, data related to net caloric intake during the first time period;
determining, using a computer, a moving average weight change per time increment per net caloric intake unit (MAWC) based upon the received data related to weight change and the received data related to net caloric intake;
receiving from the user, via a computer, data related to a spiritual status of the user during the first time period;
receiving from the user, via a computer, a weight change goal and associated second time period;
determining, using a computer, a recommended net caloric intake based upon the received weight change goal and associated second time period, and the MAWC;
receiving from the user, via a computer, data related to weight change during the second time period;
receiving from the user, via a computer, data related to net caloric intake during the second time period;
receiving from the user, via a computer, data related to a spiritual status of the user during the second time period; and
determining, using a computer, an activity recommendation based upon the received data related to the weight change, the net caloric intake, and the spiritual status of the user during the second time period and during the first period.
